(19) United States
(12) Patent Application Publication
(10) Pub. No.: US 2003/0033222 A1
(43) Pub. Date: Feb. 13, 2003

(54) Electronic shop management system

(76) Inventors: Tetsuji Fuwa, Gifu-ken (JP); Tsuyoshi Ogawa, Aichi-ken (JP)

Correspondence Address: Oliff & Berridge, P O Box 19928, Alexandria, VA, 22320, US

(21) Appl. No.: 10/204,667

(22) PCT Filed: Dec. 25, 2001
(86) PCT No.: PCT/JP01/11334

(30) Foreign Application Priority Data
Dec. 28, 2000 (JP) 2000-403177

(51) Int. Cl. G06F 17/60

(52) U.S. Cl. 705/27

(57) ABSTRACT

Distinction data for distinguishing handling products of a stamp supplier from products offered to the stamp supplier is stored in a handling product database. An information image data creating portion extracts the handling products from all products, based on the distinction data. Only the extracted products are displayed as products that the stamp supplier handles, on a Web browser of a purchaser computer. Therefore, a purchaser can readily buy a product that the purchaser desires in, for example, an electronic shopping mall using the Internet.

### BACKGROUND OF THE INVENTION

1. Field of the Invention

The invention relates to an online store management system for providing purchasers with product information about products that suppliers handle.

2. Description of the Related Art

Recently, in association with developments in computer network technology, in which the Internet is a representative example, GUI (graphical user interface) based electronic transactions using the WWW (World Wide Web), especially mail-order business between retailers (sellers) and consumers (purchasers), are actively performed. By using the WWW for the mail-order business, purchasers benefit because they can buy products promptly with a feeling of being safe after checking product information about many products on a browser. Sellers benefit because they can receive orders cheaply from a broad geographic range of consumers.

As one form of the above-described mail-order business using the WWW, there is an electronic shopping mall to which one or a plurality of retailers join. In such an electronic shopping mall, to enable a purchaser of a product to readily access to a top page of a virtual store of respective retailers and Web pages including sample images and prices of products that the respective retailers sell, generally links to these Web pages from a specific Web page that an administrator of the electronic shopping mall manages, are provided in HTML (Hyper Text Markup Language).

### SUMMARY OF THE INVENTION

Usually, there are lots of products provided to the retailers who open virtual stores in the electronic shopping mall. Some of the retailers may not desire to handle some of the products, and may handle only a part of the products. In such a case, if all product information is posted on a Web page for a virtual store of a retailer, a purchaser looking for a particular product has to check by themselves whether the products posted on the Web page for the retailer are handled by the retailer, so that troublesome operations are required for the purchaser. Further, such a case may occur that the purchaser orders a product which is not handled by the retailer.

The invention is made in view of the foregoing problems, and it is an object of the invention to provide an online store management system, an online store management method, and storage medium to enable purchasers to readily select their desired products from handling products of retailers when products are sold using a communication network, such as the Internet.

In order to achieve the above-described objectives, there is provided on an online store management system for displaying products that one supplier or a plurality of suppliers handle on a display of a communication terminal of a purchaser, through a communication network. The online store management system of the invention includes a storing means that stores product data on product information of a plurality of products offered to a supplier and distinction data for identifying the products selected as handling products by the supplier from the plurality of the products, an extracting means that extracts the products that the supplier handles from the plurality of the products, based on the distinction data stored in the storing means, and a display data creating means that reads from the storing means the product data on the products extracted by the extracting means and creates display data on the product information of the handling products, based on the read product data.

### BRIEF DESCRIPTION OF THE DRAWINGS

FIG. 1 is a block diagram showing an online store management system according to an embodiment of the invention;

FIG. 2 is a chart showing an example of contents of a product information database shown in FIG. 1;

FIG. 3 is a chart showing an example of contents of a handling product database shown in FIG. 1;

FIG. 4 is a flowchart showing handling product registration processes in terms of server operations;

FIG. 5 is a schematic view showing an example of a screen displayed in a browser of a client in one step of the handling product registration processes;

FIG. 6 is a schematic view showing an example of a screen displayed in the browser of the client in one step of the handling product registration processes;

FIG. 7 is a flowchart showing processes for displaying a handling product information page in terms of server operations;

FIG. 8 is a schematic view showing an example of a screen displayed in a browser of a client in one step of the processes for displaying the handling product information page;

FIG. 9 is a schematic view showing an example of a screen displayed in the browser of the client in one step of the processes for displaying the handling product information page;

FIG. 10 is a schematic view showing an example of a screen displayed in the browser of the client in one step of the processes for displaying the handling product information page;

FIG. 11 is a flowchart showing stamp ordering processes in terms of purchaser's ordering procedures;

FIG. 12 is a schematic view showing an example of a screen displayed in the browser of the client in one step of the stamp ordering processes; and

FIG. 13 is a schematic view showing an example of a screen displayed in the browser of the client in one step of the stamp ordering processes.

### DETAILED DESCRIPTION OF THE EMBODIMENT

A preferred embodiment of the invention will be described with reference to the drawings.

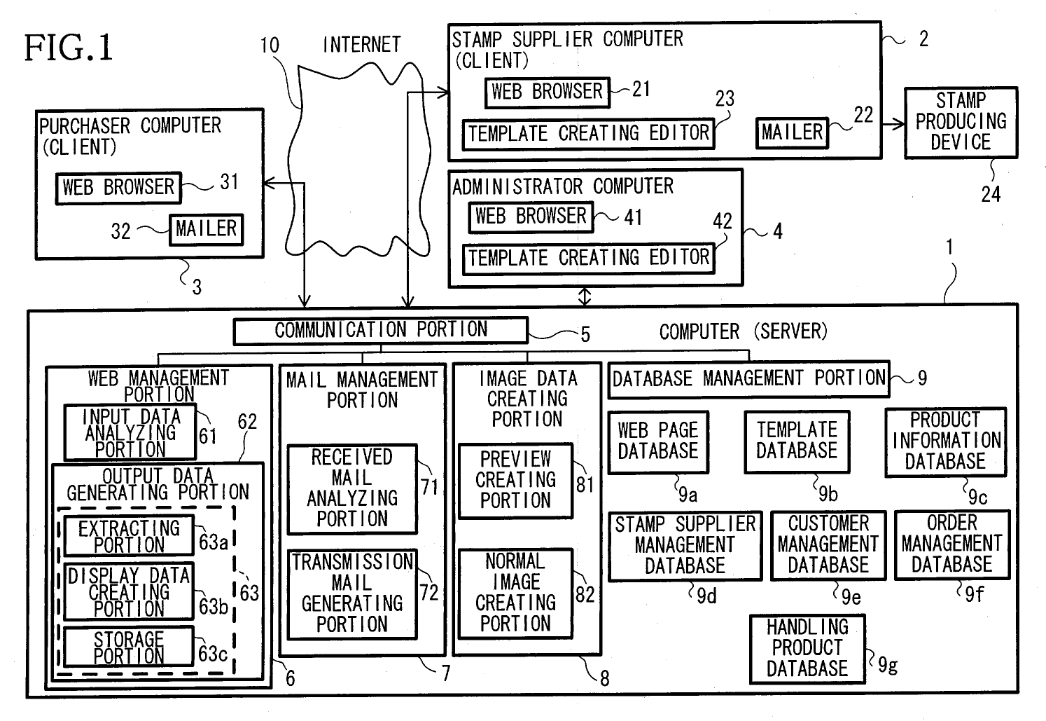

FIG. 1 is a block diagram showing a product management system according to an embodiment of the invention. The system provides product information about products handled by stamp suppliers (retailers) whose Web pages are viewed by consumers (purchasers), to the purchasers. The product management system includes a computer 1 that functions as a server, a stamp supplier computer 2 that is a client of the computer 1, a stamp purchaser computer 3 that is also a client of the computer 1, and an administrator computer 4 that performs system controls for the computer 1. The computers 1, 2, 3 are connected to each other to enable mutual data communication through the Internet 10. Although FIG. 1 shows only one client computer 2 and one client computer 3, all stamp supplier and stamp purchaser computers connected to the Internet 10 could be clients.

The server computer 1 includes a communication portion 5 that performs data transmission and reception with the computers 2, 3, using a protocol conforming with the Internet 10, a Web management portion 6 that manages transmission and reception of a Web page written in a HTML (Hyper Text Markup Language) via the Internet 10 using a HTTP (Hyper Text Transfer Protocol), a mail management portion 7 that manages transmission and reception of mail written in the HTML and/or text, via the Internet 10 using a SMTP (Simple Mail Transfer Protocol) and a POP (Post Office Protocol), an image data creating portion 8 that creates preview image data for a stamp face, a database management portion 9 that manages databases 9a, 9b, 9c, 9d, 9e, 9f, 9g, which are described below, a Web page database 9a that stores HTML files for Web pages to be transmitted to the computers 2, 3, a template database 9b that stores files concerning stamp faces, a product information database 9c that stores information about products, such as product ink colors, a stamp supplier management database 9d that stores information about stamp supplies who are registered in the server, a customer management database 9e that stores information about customers who have ordered in the past, an order management database 9f that stores information about status of orders from customers, and a handling product database (storing means) 9g that stores information about products that each stamp supplier handles.

The Web management portion 6 includes an input data analyzing portion 61 and an output data generating portion 62. The input data analyzing portion 61 analyzes a content of data supplied through the communication portion 5, via the Internet 10, based on the HTTP. The output data generating portion 62 generates HTML data that is transmitted from the communication portion 5 based on the HTTP and supplied to the computers 2, 3, in accordance with the analysis results of the input data analyzing portion 61. The output data generating portion 62 includes a handling product information page preparing portion 63. The handling product information page preparing portion 63 generates HTML data on a handling product information page that shows handling products of stamp suppliers to purchasers. The handling product information page preparing portion 63 includes an extracting portion (extracting means) 63a, a display data creating portion (display data creating means) 63b, and a storage portion 63c.

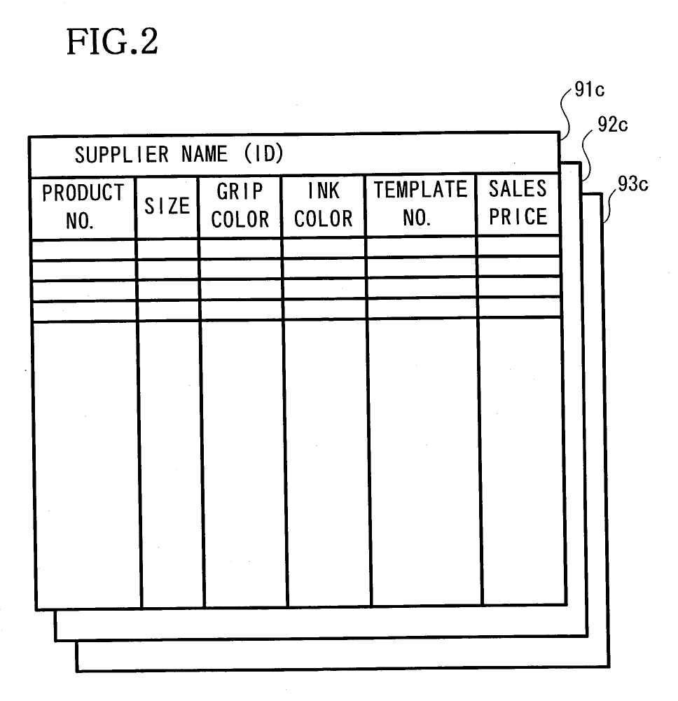

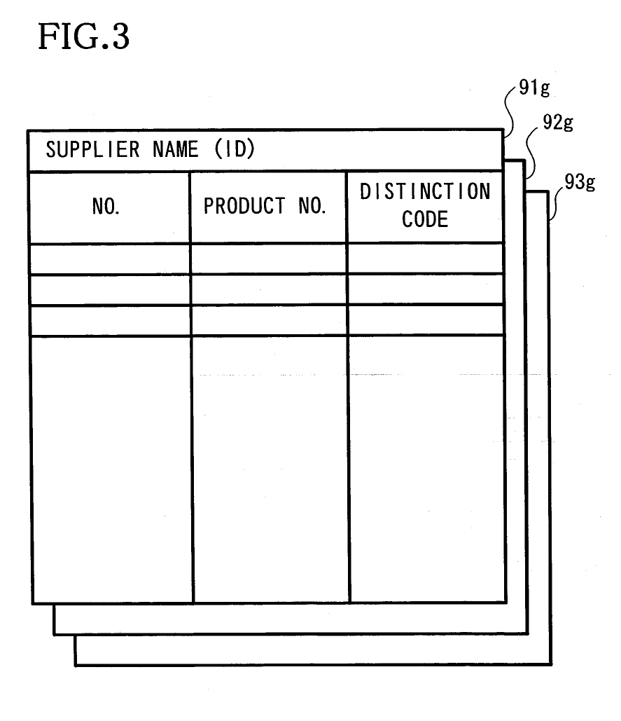

The extracting portion 63a extracts product numbers of handling products of a stamp supplier, based on distinction data (see FIG. 3) concerning the handling products of the stamp supplier that is stored in the handling product database 9g. The display data creating portion 63b extracts product information for product numbers from the product information database 9c (see FIG. 2), based on the product numbers of the products extracted by the extracting portion 63a. Further, the display data creating portion 63b extracts, based on template numbers included in the extracted product information, information about the templates for the template numbers, from the template database 9b, and generates the HTML data on the handling product information page by adding the extracted product information and the information about the templates to a information page stored in the Web page database 9a. The storage portion 63c is, for example, a RAM (Random Access Memory). The storage portion 63c temporarily stores data handled by the extracting portion 63a and the display data creating portion 63b.

The mail management portion 7 includes a received mail analyzing portion 71 and a transmission mail generating portion 72. The received mail analyzing portion 71 analyzes contents of email messages supplied through the communication portion 5 to the mail management portion 7, via the Internet 10, based on the POP. The transmission mail generating portion 72 generates email messages that are supplied through the communication portion 5 to the computers 2, 3, based on the SMTP.

The image data creating portion 8 includes a preview creating portion 81 and a normal image creating portion 82. The preview creating portion 81 creates preview image data, at approximately 90 dpi, with the address, name, and the like displayed on a sample image of a template designated by a customer, being changed to the address, name, and the like designated by the customer. The normal image creating portion 82 creates normal image data to be used when a stamp supplier produces a stamp, at approximately 600 dpi.

The database management portion 9 extracts required data from the Web page database 9a, the template database 9b, the product information database 9c, the stamp supplier management database 9d, the customer management database 9e, the order management database 9f, the handling product database 9g. The database management portion 9 controls rewriting in each database 9a, 9b, 9c, 9d, 9e, 9f, 9g.

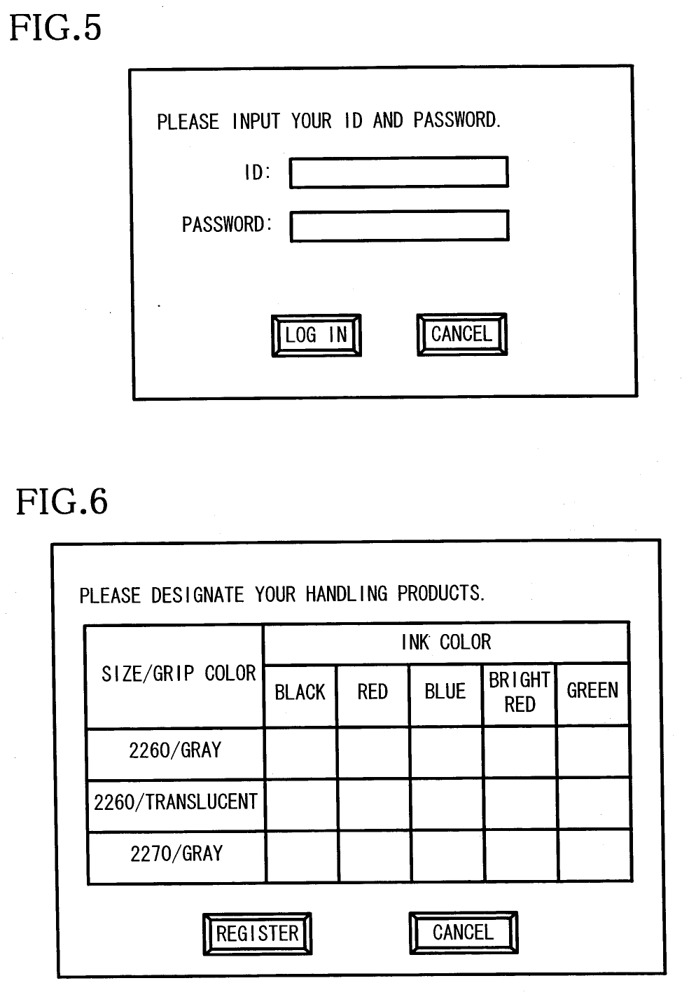

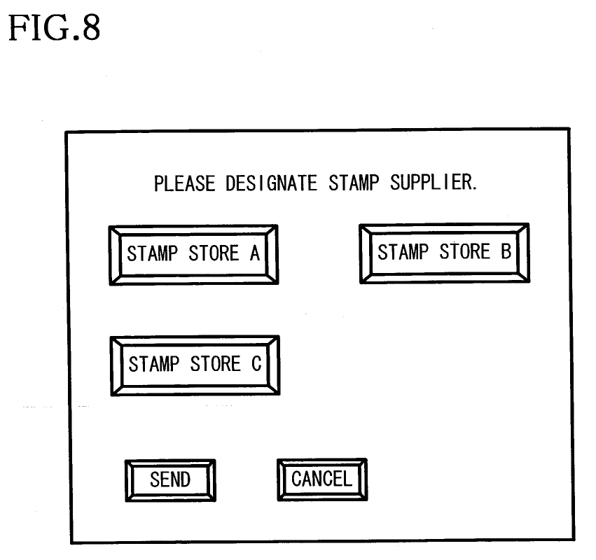

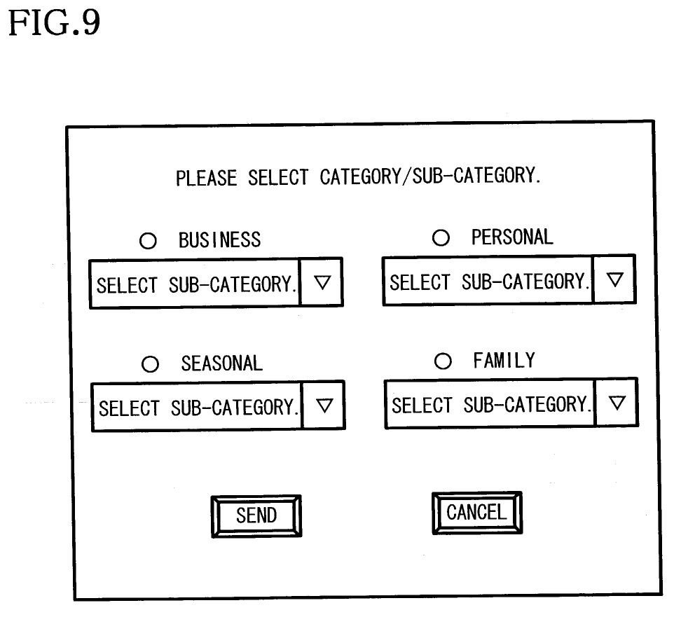

The Web page database 9a stores HTML files that are transmitted to the purchaser computer 3 in respective steps of processes for displaying the handling product information page and displayed by a browser as shown in, for example, FIGS. 8 and 9, and HTML files that are transmitted to the stamp supplier computer 2 in respective steps of handling product registration processes and displayed by a browser as shown in, for example, FIGS. 5 and 6. The HTML files stored in the Web page database 9a may be rewritten by the output data generating portion of the Web management portion 6, as necessary.

The template database 9b stores information about templates (such as sample images of stamp faces, sizes, sales prices, and layout frames), in association with predetermined template numbers (e.g., A-02 and A-03).

The product information database 9c is classified broadly into categories (such as business, personal, seasonal, and family). Each category is classified into sub-categories (e.g., office and sales for the business category). As shown in FIG. 2, product information data 91c, 92c, 93c is stored in areas of the sub-categories in each category, according to the stamp suppliers in association with stamp supplier IDs (Identifiers). Each product information data 91c, 92c, 93c is created by associating the product information (such as a stamp face size, grip color, ink color, template number, and sales price) with a product number.

The product information data 91c, 92c, 93c is provided by a system administrator to each stamp supplier. To facilitate data creation and management by the system administrator, the product information data with the same data structure is supplied to the stamp suppliers.

When a new product is added to the product information data 91c, 92c, 93c, the system administrator may initially set the sales price of the product. This may eliminate the need for the stamp supplier to input sales prices, so that stamp supplier's inputting loads can be reduced.

A structure such that the stamp supplier can change the initially set sales prices may be employed. Accordingly, the stamp supplier can change suggested sales prices at any time, as necessary.

The stamp supplier management database 9d stores an ID, which serves as an identifier of a stamp supplier who is registered in the server, and a password of the stamp supplier, in association with each other. When a new stamp supplier is to be registered in the server, the database management portion 9 adds and registers the stamp supplier in the stamp supplier management database 9d, with the ID of the stamp supplier who is newly registered, being associated with the password.

The customer management database 9e stores information about customers who have ordered in the past (such as name, age, gender, and address), in association with IDs, which serve as identifiers for the customers. When a new customer who has not placed an order in the past, orders, the database management portion 9 adds and registers the customer in the customer management database 9e, with the ID of the new customer associated with the customer information. As the customer information, information that indicates whether a customer caused any troubles in the past when the customer purchases a product, may be added. Such information is stored as blacklist data. As the customer IDs, an email address that the customers have may be adopted. This can save the server from having to issue the IDs. Further, the customer IDs and email address do not have to be stored redundantly. As the customer IDs and passwords, a cookie file that is transmitted from the server computer 1 and stored in the purchaser computer 3, may be used. This can save purchasers from having to input the IDs and passwords.

The order management database 9f stores each order number and information about an order (such as date ordered, delivery date, payment method, and dispatched or not), in association with each other. When a new order of a product is placed, the database management portion 9 adds and registers a record about the order in the order management database 9f, in association with the ID of the customer who placed the order.

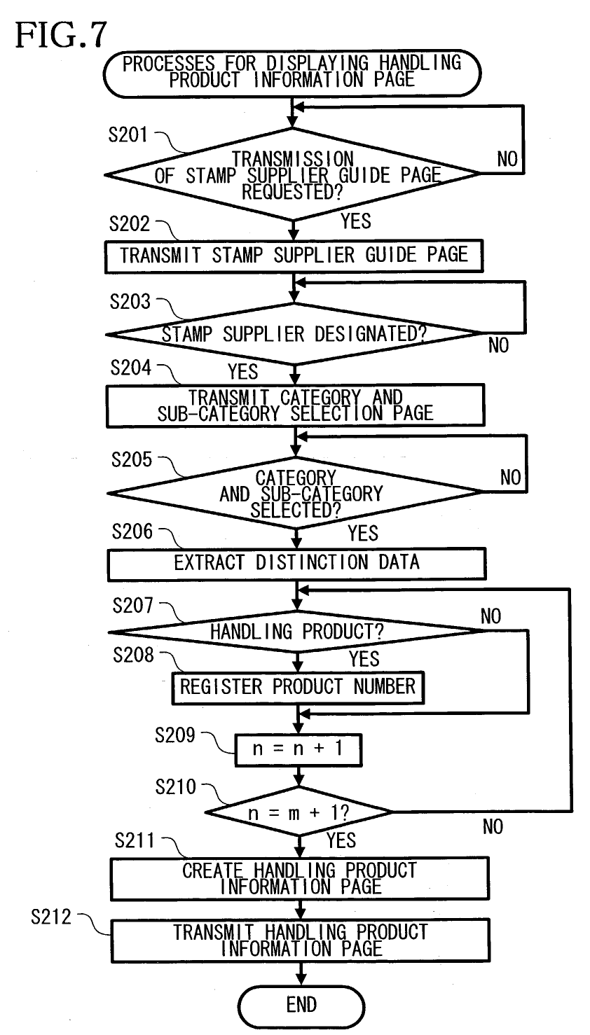

The handling product database 9g is classified broadly into categories. Each category is classified into sub-categories. As shown in FIG. 3, distinction data 91g, 92g, 93g is stored in areas of the sub-categories in each category, according to the stamp suppliers in association with the stamp supplier IDs. Each distinction data 91g, 92g, 93gis created by associating the product number and a distinction code for distinguishing between the handling products and non-handling products, with a number. The number is used in the processes for displaying the handling product information page, which will be described below, to select a product subjected to determination between a handling product and a non-handling product (see steps S207 to S210 in FIG. 7). The number is given sequentially from 1. For example, “1” is assigned, as distinction data, to products that a stamp supplier handles, and “0” is assigned, as distinction date, to products that the stamp supplier does not handle.

The client supplier computer 2 is installed with a browser 21, which is Web viewing software, and a mailer 22, which is mail transmission and reception software, as well as a template creating editor 23 for a stamp supplier who is an owner of the computer 2 to create templates for their own stamp faces. The computer 2 is connected to a stamp producing device 24. The stamp producing device 24 is for producing a stamp with characters and the like on a stamp face corresponding to the order received from the computer 3 through the computer 1. When a stamp is produced using the stamp producing device 24, the normal image data created by the normal image creating portion 82 and downloaded from the computer 1, is used.

The client purchaser computer 3 is installed with a browser 31, which is Web viewing software, and a mailer 32, which is mail transmission and reception software.

The administrator computer 4 is installed with a browser 41, which is Web viewing software, as well as a template creating editor 42 for the system administrator to create templates for stamp faces to be provided to the stamp suppliers.

Next, various processes performed in the online store management system having the above-described structures are described with reference to the drawings.

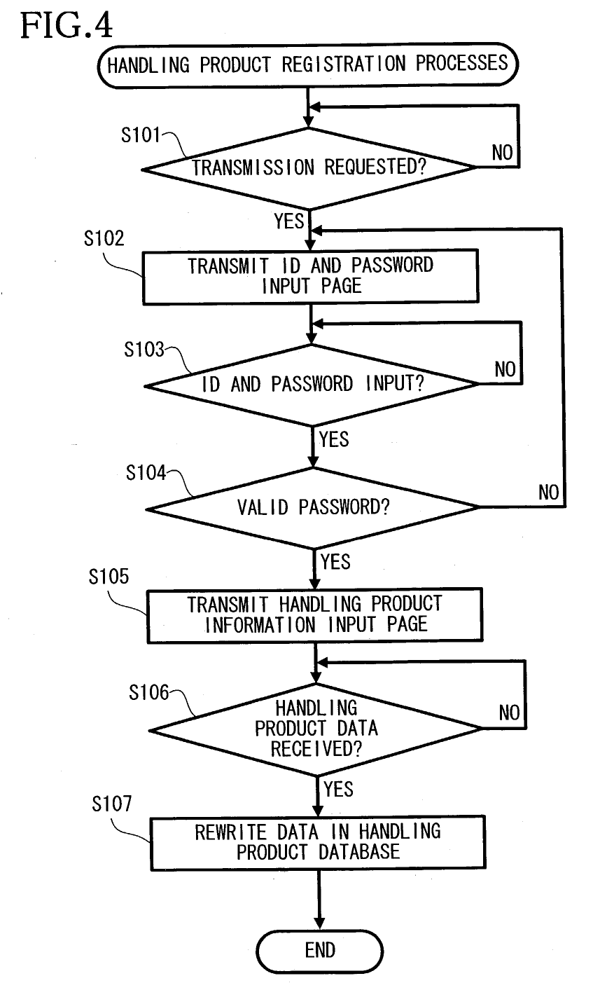

First, processes for registering handling products in the handling product database 9f are described with reference to FIGS. 4 to 6. FIG. 4 is a flowchart showing the handling product registration processes in terms of server operations. FIGS. 5 and 6 are schematic view showing examples of pages displayed in the browser 21 of the supplier computer 2 in one step of the handling product registration processes.

In step S101, the input data analyzing portion 61 of the Web management portion 6 determines whether transmission of a Web page for asking a stamp supplier to input an ID and password is requested. When the transmission is requested (S101:YES), flow goes to the process in step S102.

In step S102, a file to display, on the browser 21 of the supplier computer 2, an ID and password input page shown in FIG. 5 is extracted from the Web page database 9a by the database management portion 9, and transmitted from the communication portion 5 to the computer 2.

Then, the ID and password input page is displayed on the Web browser of the computer 2. In the ID and password input page, the stamp supplier inputs the ID and password. After input, the stamp supplier clicks on “LOG IN” button. Accordingly, data on the ID and password is transmitted from the computer 2 to the computer 1.

In step S103, the input data analyzing portion 61 of the Web management portion 6 of the computer 1 determines whether the data on the ID and password is received from the computer 2. When the data on the ID and password is received from the computer 2 (S103:YES), flow goes to the process in step S104.

In step S104, the input data analyzing portion 61 of the Web management portion 6 further determines whether the input password is valid, based on the IDs stored in the stamp supplier management database 9d and the passwords associated with the IDs. When it is determined that the password is invalid (S104:NO), flow returns to the process in step S102, and the processes in steps S102 to S104 are performed again. When it is determined that the password is valid (S104:YES), flow goes to the process in step S105.

In step S105, a file to display, on the browser 21 of the supplier computer 2, a handling stamp information input page shown in FIG. 6, is extracted from the Web page database 9a by the database management portion 9, and transmitted from the communication portion 5 to the computer 2.

FIG. 6 is an example of the page to be used by the stamp supplier when selecting stamp types (sizes, grip colors, and ink colors) that the stamp supplier handles. The page is structured such that “size/grip color” and “ink color” of stamps can be selected.

Then, the handling stamp information input page is displayed on the Web browser of the computer 2. In the handling stamp information input page, the stamp supplier selects the sizes, grip colors, and ink colors of their handling products by clicking on the applicable boxes for the size/grip color and ink color. After selection, the stamp supplier clicks on REGISTER button. Accordingly, handling product data for distinguishing between products that the stamp supplier handles and does not handle, is transmitted from the computer 2 to the computer 1.

In step S106, the input data analyzing portion 61 of the Web management portion 6 determines whether the handling product data is received from the computer 2. When the handling product data is received from the computer 2 (S106:YES), flow goes to the process in step S107.

In step S107, the database management portion 9 changes, based on the stamp supplier ID received in step S103 and the handling product data received in step S106, the distinction data 91g, 92g, 93g stored in the handling product database 9g and associated with the stamp supplier ID. That is, the database management portion 9 sets “1” for the distinction code associated with the product number of a product, for which clicking is performed, in the distinction data associated with the stamp supplier ID.

Each distinction data 91g, 92g, 93g in the handling product database 9g is created by each process in the above-described steps S101 to S107, such that the handling products of the stamp supplier can be distinguished.

Next, processes for displaying the handling product information page on the Web browser 31 of the purchaser computer 3 will be described with reference to FIGS. 7 to 10. FIG. 7 is a flowchart showing processes for displaying the handling product information page in terms of server operations. FIGS. 8 to 10 are schematic view showing examples of pages displayed in the browser 31 of the computer 3 in one step of the processes for displaying the handling product information page.

In step S201, the input data analyzing portion 61 of the Web management portion 6 determines whether transmission of a Web page for asking a purchaser to designate a stamp supplier is requested. When the transmission is requested (S201:YES), flow goes to the process in step S202.

In step S202, a file to display, on the browser 31 of the purchaser computer 3, a stamp supplier guide page shown in FIG. 8 is extracted from the Web page database 9a by the database management portion 9, and transmitted from the communication portion 5 to the computer 3.

Then, the stamp supplier guide page is displayed on the Web browser of the computer 3. In the stamp supplier guide page, the purchaser selects a desired stamp supplier by clicking on a button for the stamp supplier. After selection, the purchaser clicks on SEND button. Accordingly, data on the designated stamp supplier is transmitted from the computer 3 to the computer 1.

In step S203, the input data analyzing portion 61 of the Web management portion 6 of the computer 1 determines whether the data on the designated stamp supplier is received from the computer 3. When the data on the stamp supplier is received from the computer 3 (S203:YES), flow goes to the process in step S204.

In step S204, a file to display, on the browser 31 of the computer 3, a category and sub-category selection page shown in FIG. 9, is extracted from the Web page database 9a by the database management portion 9, and transmitted from the communication portion 5 to the computer 3.

Then, the category and sub-category selection page is displayed on the Web browser 31 of the computer 3. In the category and sub-category selection page, the purchaser selects a category by clicking on a box associated with the category, as well as a sub-category using an option menu (pull-down menu) for the selected category. After selection, the purchaser clicks on SEND button. Accordingly, data on the selected category/sub-category is transmitted from the computer 3 to the computer 1.

In step S205, the input data analyzing portion 61 of the Web management portion 6 of the computer 1 determines whether the data on the selected category/sub-category is received from the computer 3. When the information about the selection of the category/sub-category is received from the computer 3 (S205:YES), flow goes to the process in step S206.

In step S206, the handling product extracting portion 63a extracts from the handling product database 9g the distinction data (see FIG. 3) for the designated stamp supplier, which is indicated in the data received in step S203, and belonging to the category/sub-category according to the data received in step S205, based on the stamp supplier ID. The extracted distinction data is temporarily stored in the storage portion 63c.

In step S207, the handling product extracting portion 63a determines, based on the distinction data stored in the storage portion 63c in step S206, whether the distinction code associated with a number “n” is “1”, that is, whether a product with its product number associated with the number “n” is a handling product. When it is determined that the product is a handling product (S207:YES), flow goes to the process in step S208. When it is determined that the product is not a handling product (S207:NO), flow goes to the process in step S209. As an initial setting for “n”, “1” is set.

In step S208, the handling product extracting portion 63a temporarily stores the product number associated with the number “n” in the storage portion 63c.

In step S209, the handling product extracting portion 63a increments the number “n” by one (n=n+1).

In step S210, the handling product extracting portion 63a determines whether the number “n” is equal to “m+1”. When the number “n” is not equal to “m+1” (S210:NO), flow goes to the process in step S207 and each process in steps S207 to S208 is performed. When the number “n” is equal to “m+1” (S210:YES), flow goes to the process in step S211. “m” refers to the number of products belonging to the selected sub-category in the category, which is indicated in the data received in step S205.

Through a series of processes in the above-described steps S206 to S210, only the product numbers of the products of the designated stamp supplier, which is indicated in the data received in step S203 and belonging to the selected category/sub-category, which is indicated in the data received in step S204, are extracted and temporarily stored in the storage portion 63c.

In step S211, the data creating portion 63b generates HTML data on the handling product information page that shows the handling products of the designated stamp supplier, which is indicated in the data received in step S203. That is, a file for the information page is extracted by the data creating portion 63b from the Web page database 9a. In addition, the data creating portion 63b extracts, based on the product numbers temporarily stored in the storage portion 63c, the product information (see FIG. 2) associated with the product numbers, from the product information database 9c. Further, based on the template numbers included in the extracted product information, the information about the templates associated with the template numbers is extracted from the template database 9b. The data creating portion 63b generates the HTML data on the handling product information page, by adding the extracted information about the templates to the information page.

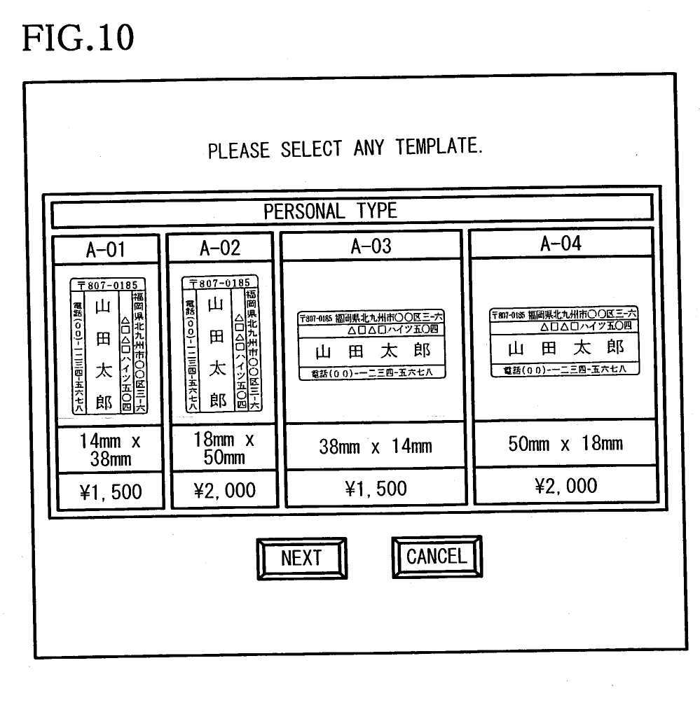

In step S212, the HTML data (including sample image data of the templates) to display the stamp supplier's handling product information page shown in FIG. 10, on the browser 31 of the computer 3, is transmitted from the communication portion 5 to the computer 3 by the Web management portion 6.

Through a series of processes in the above-described steps S201 to S212, the handling product information page illustrated in FIG. 10 that only shows the handling products of the stamp supplier designated by the purchaser and belonging to the category/sub-category selected by the purchaser, is displayed on the Web browser 31 of the purchaser computer 3.

FIG. 10 is an example of the page for a stamp supplier to inform purchasers of their handling stamps. A plurality of products that the stamp supplier handles are shown on the page. A stamp face sample, stamp face size, and sales price of each product are also indicated on the page. Together with such information, a grip color and ink color to be handled for each of the products may be indicated.

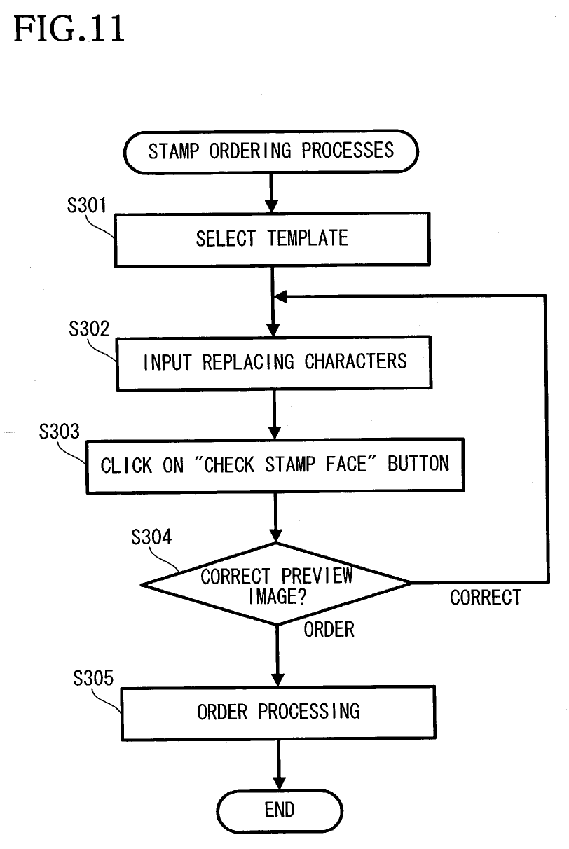

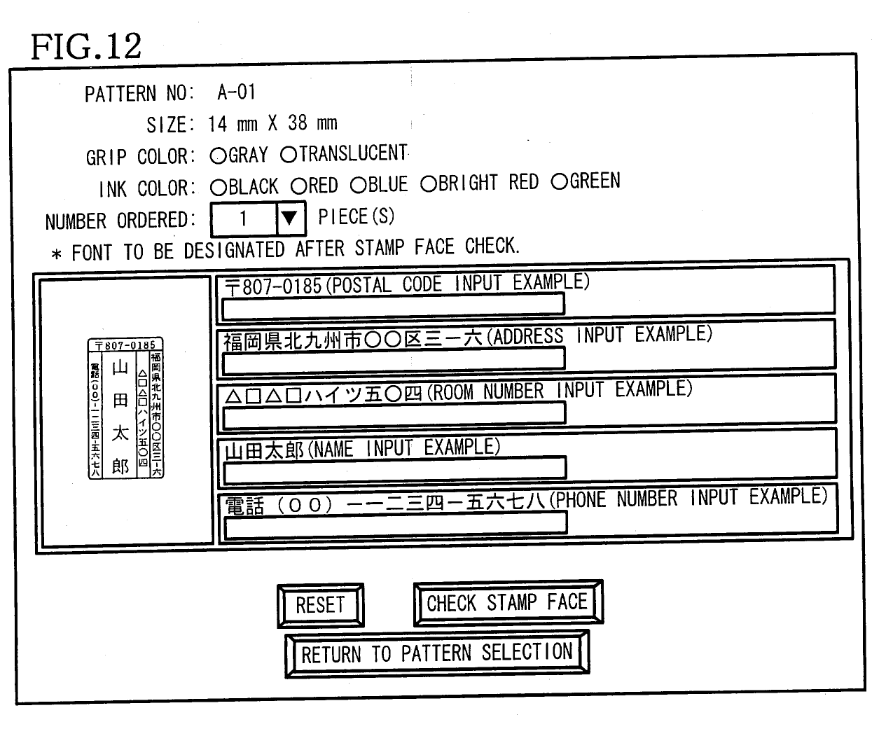

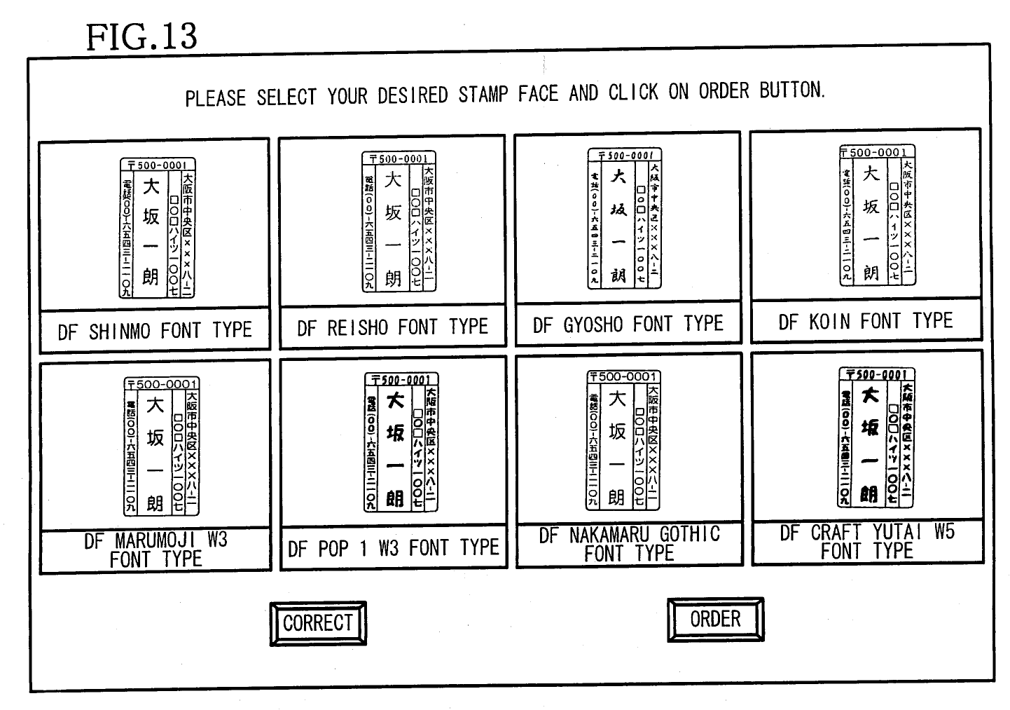

Further, stamp ordering processes to be performed by the purchaser will be described with reference to FIGS. 11 to 13. FIG. 11 is a flowchart showing stamp ordering processes in terms of purchaser's ordering procedures. FIGS. 12 and 13 are schematic view showing examples of pages displayed on the browser 31 of the computer 3 in one step of the stamp ordering processes.

In step S301, the purchaser selects a desired product, by clicking on a template button for the product, from a plurality of products in the handling product information page displayed on the Web browser 31 of the computer 3 by the above-described processes for displaying the handling product information page. After selection, the purchaser clicks on NEXT button.

In step S302, when the purchaser clicks on NEXT button, a replacing character input page shown in FIG. 12 is displayed on the Web page. The purchaser inputs the postal code, address, name, and telephone number, and selects the grip color of the stamp, the ink color, and the number of stamps to be ordered.

FIG. 12 is an example of the page to input characters and the like that the purchaser desires on the stamp face. In the page, a stamp face sample is shown. In addition, the page is structured such that the grip color, ink color, number of stamps to be ordered, and character information desired on the stamp face (postal code, address, name, and telephone number) can be selected or input. When a desired grip color is selected by the purchaser, only ink colors prepared for the desired grip color are shown in ink color selection items.

In step S303, after inputting the grip color, the ink color, the number of stamp to be ordered, and characters to be indicated on the stamp face in step S302, the purchaser clicks on “CHECK STAMP FACE” button. When “CHECK STAMP FACE” button is clicked on, the input information input by the purchaser is transmitted from the computer 3 to the computer 1, via the Internet 10. Preview images, in a plurality of font types shown in FIG. 13, with the information replaced with the input information by the preview generating portion 81 of the image data generating portion 8 of the computer 1, are displayed on the Web page 31 of the computer 3.

FIG. 13 is an example of the page for the purchaser to check whether characters to be indicated on the stamp face (postal code, address, name, and telephone number) are correct and to select a desired font. The page posts a plurality of samples of stamp faces with characters, which are pre-designated by the stamp supplier, printed in a plurality of font types.

In step S304, the purchaser checks the contents of the preview image. When the contents of the information (postal code, address, name, and telephone number) on the stamp face is correct, the purchaser clicks on a stamp face with a desired font, and then ORDER button. If there are typographical errors in the information on the stamp face, CORRECT button is clicked on. When CORRECT button is clicked on (S304:CORRECT), flow returns to the process in step S302, and the processes in steps S302 to S304 are performed again. When ORDER button is clicked on (S304:ORDER), flow goes to the process in step S305. In step S305, the purchaser inputs order contents, such as the stamp delivery address. Thereafter, the normal image data created by the normal image creating portion 82 is downloaded to the supplier computer 2. The supplier creates the stamp, based on the normal image data, using the stamp producing device 24, and sends the stamp to the purchaser.

In the stamp ordering processes that have been described using the flowchart in FIG. 11, a desired product (stamp face, size, grip color, ink color, and font) is ordered using the handling product information page showing only the products that a stamp supplier handles. Therefore, a product that a purchaser orders is definitely the stamp supplier's handling product. In addition, the purchaser can designate information to be printed on the stamp face, so that the stamp with characters that the purchaser desires, printed can be ordered.

As described above, according to the embodiment, only the information about products that stamp suppliers handle is provided to purchasers. Therefore, the purchasers can readily search for their desired products from the handling products of the stamp suppliers. In addition, situations such that the stamp suppliers' non-handling products are ordered can be prevented. Therefore, convenience of mail-order business in an electronic shopping mall, to which a plurality of virtual stores join, increases, and the use of mail-order business can be promoted.

While the preferred embodiment of the invention has been described above, the invention is not limited to the above-described embodiment. Various changes that fall within the scope of the claims can be made. For example, the invention can be applied to products with a plurality of types, such as televisions, and unique information indicating products, such as business cards, nameplates, and New Year's cards, other than stamps. Further, the online store management system of the invention is not limited to the above-described embodiment and, for example, the Web management portion and various databases may belong to separate computers. In addition, the administrator computer 4 may be included in the sever computer 1, or connected to the server computer 1 through the Internet 10. Further, invention can be applied not only when an electronic shopping mall to which a plurality of virtual stores join is provided on the server computer 1, but also when a supplier uses their own computer as a server computer.

Product data provided to a plurality of suppliers is common. Therefore, the creation/management of the product data provided to the plurality of the suppliers can be facilitated.

Further, when a new product is added, the sales price is set by the system administrator. Therefore, supplier's loads to input data on sales prices can be reduced.

Suppliers can input sales prices. Accordingly, the suppliers' suggested sales prices can be changed at any time, as necessary, and presented to the purchasers.

The online store management system can accommodate the orders of unique information indicating products, such as stamps, business cards, nameplates, and New Year's cards.

Further, there is provided an online store management method for displaying products that one supplier or a plurality of suppliers handle on a display of a communication terminal of a purchaser, through a communication network. The online store management method includes a storing step in which product data on product information of a plurality of products offered to a supplier and distinction data for identifying the products selected as handling products by the supplier from the plurality of the products, are prestored in a storing means, an extracting step in which the products that the supplier handles are extracted from the plurality of the products, based on the distinction data stored in the storing means, and a display data creating step in which the product data on the products extracted in the extracting step is read from the storing means, and display data on the product information of the handling products is created based on the read product data.

Further, the invention relates to a computer-readable storage medium that stores a program. The program stored in the storage medium to function an online store management system for displaying products that one supplier or a plurality of suppliers handle on a display of a communication terminal of a purchaser through a communication network, includes a storing program for storing product data on product information of a plurality of products offered to a supplier and distinction data for identifying the products selected as handling products by the supplier from the plurality of the products, an extracting program for extracting the products that the supplier handles from the plurality of the products, based on the distinction data stored in the storing means, and a display data creating program for reading from the storing means the product data on the products extracted by the extracting means and creating display data on the product information of the handling products, based on the read product data.

Only the information about products that the supplier handles is provided to the purchaser. Therefore, the purchaser can readily search for their desired products from the handling products of the supplier. In addition, situations such that products other than those handled by the supplier are ordered by the purchaser, can be prevented. Thus, convenience is increased. In the invention, any well-known networks such as the Internet, LAN (Local Area Network), and WAN (Wide Area Network) may be used as the communication network.

In the online store management system of the invention described in the embodiment, the product data is common to the plurality of the suppliers. Because the product data provided to the plurality of suppliers is common, the creation/management of the product data provided to the plurality of the suppliers can be facilitated.

In the online store management system of the invention described in the embodiment, a piece of the product information of the products is sales prices of the products of the supplier and an administrator of the online store management system is allowed to initially set the sales prices of the products that are newly added to the product data. When a new product is added to the product data, the sales price is set by the system administrator, so that supplier's loads to input data on sales price can be reduced.

Further, the supplier is allowed to change the sales prices that are initially set. Because the supplier can input the sales prices, the suppliers' suggested sales prices can be changed at any time, as necessary, and presented to the purchaser.

In the online store management system of the invention described in the embodiment, the products may be unique information indicating products that indicate unique information. The online store management system can accommodate the orders of the unique information indicating products, such as stamps, business cards, nameplates, and New Year's cards. The unique information indicating products include stamps, business cards, and New Year's cards on which information of individuals or companies (e.g., names, addresses, postal codes, telephone numbers, and email addresses of individuals or companies) is indicated using a plate or by printing. In the invention, the unique information includes a variety of information, for example, personal information, such as names, addresses, postal codes, telephone numbers, and email addresses of individuals or groups of individuals, such as companies, as well as creative text, catch phrases, and combinations of symbols that have a particular meaning.

In the invention, such troublesome operations are not required for purchasers that the purchasers have to check whether a product posted on a Web page of a supplier is a handling product of the retailer. In addition, situations such that the purchasers order a retailer's non-handling product do not occur. Therefore, even when virtual stores of a plurality of suppliers particularly sell the same kinds of products in an electronic shopping mall, inconvenience to purchasers is not brought about. Thus, the online store management system can contribute to the expansion of the mail-order business using communication networks, such as the Internet.

What is claimed is:

1. An online store management system for displaying products that one supplier or a plurality of suppliers handle on a display of a communication terminal of a purchaser, through a communication network, comprising:
storing means that stores product data on product information of a plurality of products offered to a supplier and distinction data for identifying the products selected as handling products by the supplier from the plurality of the products;
extracting means that extracts the products that the supplier handles from the plurality of the products, based on the distinction data stored in the storing means; and
display data creating means that reads from the storing means the product data on the products extracted by the extracting means and creates display data on the product information of the handling products, based on the read product data.

2. The online store management system as claimed in claim 1, wherein the product data on the product information of the plurality of the products offered to the supplier is common to the plurality of the suppliers.

3. The online store management system as claimed in claim 1, wherein a piece of the product information of the products is sales prices of the products of the supplier and an administrator of the online store management system is allowed to initially set the sales prices of the products that are newly added to the product data.

4. The online store management system as claimed in claim 3, wherein the supplier is allowed to change the sales prices that are initially set.

5. The online store management system as claimed in claim 1, wherein the products are unique information indicating products that indicate unique information.

6. An online store management method for displaying products that one supplier or a plurality of suppliers handle on a display of a communication terminal of a purchaser, through a communication network, comprising:
a storing step in which product data on product information of a plurality of products offered to a supplier and distinction data for identifying the products selected as handling products by the supplier from the plurality of the products, are prestored in a storing means;
an extracting step in which the products that the supplier handles are extracted from the plurality of the products, based on the distinction data stored in the storing means; and
a display data creating step in which the product data on the products extracted in the extracting step is read from the storing means, and display data on the product information of the handling products is created based on the read product data.

7. A computer-readable storage medium that stores a program to function an online store management system for displaying products that one supplier or a plurality of suppliers handle on a display of a communication terminal of a purchaser through a communication network,
the program including:
a storing program for storing product data on product information of a plurality of products offered to a supplier and distinction data for identifying the products selected as handling products by the supplier from the plurality of the products;
an extracting program for extracting the products that the supplier handles from the plurality of the products, based on the distinction data stored in the storing means; and
a display data creating program for reading from the storing means the product data on the products extracted by the extracting means and creating display data on the product information of the handling products, based on the read product data.

8. An online store management system, comprising:
product data storing means that stores product data on a plurality of products that at least one supplier handles;
distinction data storing means that creates distinction data in the product data selected by the at least one supplier from the product data on the plurality of products, and stores the distinction data;
product data extracting means that extracts the product data on product information of the products that the at least one supplier handles, based on the distinction data stored by the product data storing means and the distinction data storing means;
display data creating means that creates display data on the product information of handling products that at least one supplier handles, based on the product data on the products extracted by the product data extracting means; and
transmission means that transmits the display data so as to display the display data created by the display data creating means on a display of a communication terminal of a purchaser, through a communication network.
